(19) United States
(12) Patent Application Publication
(10) Pub. No.: US 2025/0375835 A1
(43) Pub. Date: Dec. 11, 2025

(54) LASER MARKING APPARATUS AND LASER MARKING METHOD

(71) Applicant: SINTOKOGIO, LTD., Nagoya-shi (JP)

(72) Inventors: Yasuaki ASAOKA, Toyokawa-shi (JP); Kazunori OGURA, Toyokawa-shi (JP); Takehiro SUGINO, Toyokawa-shi (JP)

(73) Assignee: SINTOKOGIO, LTD., Nagoya-shi (JP)

(21) Appl. No.: 19/301,127

(22) Filed: Aug. 15, 2025

Related U.S. Application Data
(62) Division of application No. 17/215,863, filed on Mar. 29, 2021.

(30) Foreign Application Priority Data
Apr. 3, 2020 (JP) 2020-067754

(51) Int. Cl. B23K 26/359; B23K 26/04; B23K 26/06; B23K 26/08; B23K 26/12; B23K 26/14; B23K 26/16; B23K 26/70; B23K 37/04; B41M 5/24

(52) U.S. Cl. CPC B23K 26/359; B23K 26/048; B23K 26/0665; B23K 26/0884; B23K 26/127; B23K 26/1462; B23K 26/16; B23K 26/702; B23K 37/04; B41M 5/24

(57) ABSTRACT

A laser marking apparatus includes a blowing unit configured to blow gas onto a surface of a mold, a head configured to mark an identifier on the mold by applying laser light to the surface of the mold; and a control unit configured to cause the head to mark the identifier while the blowing unit blows the gas.

### CROSS-REFERENCE TO RELATED APPLICATION

This application is based on Japanese Patent Application No. 2020-067754 filed with Japan Patent Office on Apr. 3, 2020, the entire contents of which are hereby incorporated by reference.

### TECHNICAL FIELD

The present disclosure relates to a laser marking apparatus and a laser marking method.

### BACKGROUND

Japanese Unexamined Patent Publication No. S63-299842 discloses a laser marking method for marking an identifier on a mold formed of green sand by applying laser light to the mold. In this method, the green sand of the mold is cured with resin before laser light is applied to the mold. This stabilizes the shape of the identifier marked by the application of laser light.

### SUMMARY

Incidentally, when an identifier is marked on a mold by using laser light, vapor or a residue may be generated from the mold due to the application of laser light. The generated vapor or residue may block laser light. When laser light is not sufficiently applied to the surface of the mold, the marked identifier may become unclear. The present disclosure provides a laser marking apparatus capable of reducing the influence of vapor or a residue generated from a mold due to the application of laser light on a marking operation.

A laser marking apparatus according to one aspect of the present disclosure includes blowing unit configured to blow gas onto a surface of a mold; a head configured to mark an identifier on the mold by applying laser light to the surface of the mold; and a control unit configured to cause the head to mark the identifier while the nozzle blows the gas.

In the laser marking apparatus, the gas is blown onto the surface of the mold. The laser light is applied to the surface of the mold during the blowing of the gas. Vapor or a residue generated from the mold due to the application of the laser light is removed from the surface of the mold by the blowing unit blowing the gas onto the surface of the mold. Thus, the laser light is applied to the surface of the mold while maintaining a set output of the laser light without being blocked by the vapor or residue generated from the mold. Thus, the laser marking apparatus can reduce the influence of the vapor or residue generated from the mold due to the application of the laser light on the marking operation. In one embodiment, the blowing unit may include a nozzle blowing the gas onto the surface of the mold, and the nozzle and the head integrally move. In this case, since the nozzle moves integrally with the head, the gas is appropriately blown onto the surface of the mold even when the head moves. In one embodiment, the nozzle may be provided on the head. In this case, the structure can be simplified as compared to a case where a driving mechanism is provided for each of the head and the nozzle.

In one embodiment, the laser marking apparatus may further include a case defining an operation space for marking the identifier; and a dust collector connected to the operation space. In this case, the vapor or residue removed from the surface of the mold by the blowing unit is collected by the dust collector. Thus, the laser light is applied to the surface of the mold while maintaining the set output of the laser light without being blocked by the generated vapor or residue. Thus, the laser marking apparatus can further reduce the influence of the vapor or residue generated from the mold due to the application of the laser light on the marking operation.

In one embodiment, the laser marking apparatus may further include a positioning unit fixing the mold at a predetermined operation position. In this case, the mold is marked with the identifier after being fixed at the predetermined operation position by the positioning unit. Thus, the laser marking apparatus can suppress the occurrence of misalignment or marking failure of the identifier caused by misalignment of the mold.

In one embodiment, the laser marking apparatus may further include a robot changing a vertical position, a horizontal position, and a height position of the head. The laser marking apparatus can change the vertical position, the horizontal position, and the height position of the head by using the robot.

In one embodiment, the laser marking apparatus may further include a measurement unit measuring a distance between the head and the surface of the mold. The control unit may adjust at least one of a height position of the head and a focal length of the laser light on the basis of the distance measured by the measurement unit. In this case, the control unit adjusts the distance between the head and the surface of the mold to a set value on the basis of the distance measured by the measurement unit. Thus, the laser marking apparatus can clearly mark the identifier on the mold even when the height position of the surface of the mold varies.

In one embodiment, the laser marking apparatus may further include a spraying unit spraying liquid onto the surface of the mold after the head marks the identifier. In this case, water evaporating due to the application of the laser light is compensated with the liquid sprayed by the spraying unit. Thus, the laser marking apparatus can reduce the influence of the marking operation on the quality of the mold.

A laser marking method according to another aspect of the present disclosure includes blowing gas onto the surface of the mold, and marking the identifier on the mold by applying the laser light to the surface of the mold during the blowing of the gas.

In the laser marking method, the gas is blown onto the surface of the mold. The laser light is applied to the surface of the mold during the blowing of the gas. Vapor or a residue generated from the mold is removed from the surface of the mold by blowing the gas onto the surface of the mold. Thus, the laser light is applied to the surface of the mold while maintaining a set output of the laser light without being blocked by the vapor or residue generated from the mold. Thus, the laser marking method can reduce the influence of the vapor or residue generated from the mold due to the application of the laser light on the marking operation. In one embodiment, the method may be performed by a laser marking apparatus, the laser marking apparatus including a head configured to mark an identifier on a mold by applying laser light to the surface of the mold, and a nozzle configured to move integrally with the head and blow gas onto the surface of the mold. In this case, since the nozzle moves integrally with the head, the gas is appropriately blown onto the surface of the mold even when the head moves.

The present disclosure provides a laser marking apparatus capable of reducing the influence of vapor or a residue generated from a mold due to the application of laser light on a marking operation.

### BRIEF DESCRIPTION OF THE DRAWINGS

FIG. 1 is a configuration diagram schematically illustrating an example of a casting system including a laser marking apparatus according to an embodiment;

FIG. 2 is a sectional view illustrating an example of the laser marking apparatus according to the embodiment;

FIG. 3 is a sectional view illustrating an example of a laser marking apparatus including a dust collector;

FIG. 4 is a top view illustrating an example of a laser marking apparatus including a positioning unit;

FIG. 5 is a sectional view illustrating an example of a laser marking apparatus including a robot;

FIG. 6 is a sectional view illustrating an example of a laser marking apparatus including a measurement unit;

FIG. 7 is a sectional view illustrating an example of a laser marking apparatus including a spraying unit;

FIG. 8 is a sectional view illustrating another example of the laser marking apparatus including the spraying unit;

FIG. 9 is a flowchart illustrating an example of operation of the laser marking apparatus; and

FIG. 10 is a sectional view illustrating another example of the laser marking apparatus including the dust collector.

### DETAILED DESCRIPTION

Hereinbelow, an embodiment of the present disclosure will be described with reference to the drawings. Note that, in the following description, identical reference signs designate identical or corresponding elements to omit redundant description. The dimensional ratio in the drawings does not necessarily coincide with an actual ratio. The “up”, “down”, “left” and “right” are based on an illustrated state and used for convenience sake. The X direction and the Y direction in the drawings indicate the horizontal direction, and the Z direction in the drawings indicates the vertical direction.

### Example of Casting System

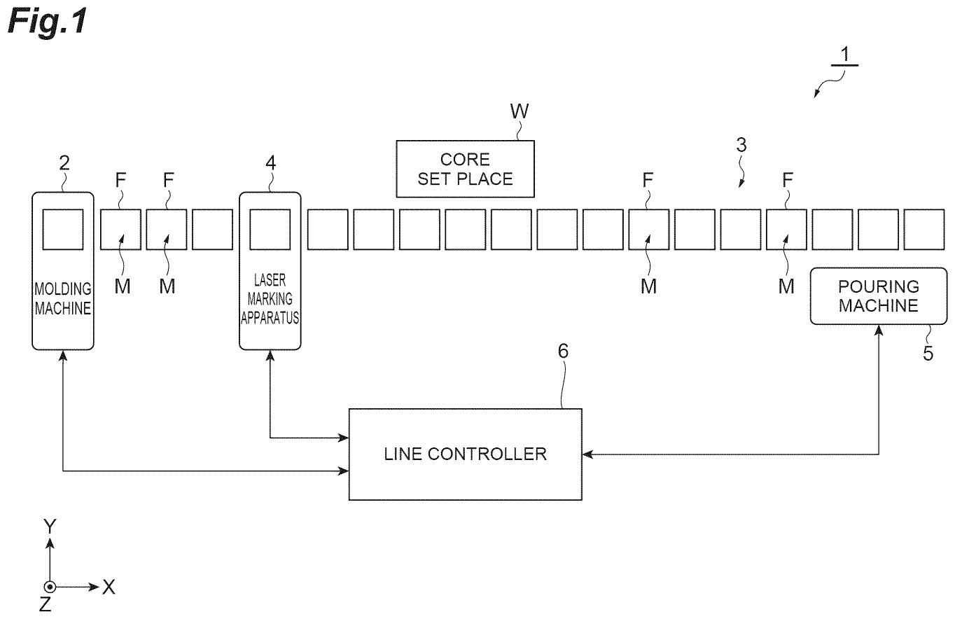

FIG. 1 is a configuration diagram schematically illustrating an example of a casting system including a laser marking apparatus according to an embodiment. A casting system 1 illustrated in FIG. 1 is a system for manufacturing casts. The casting system 1 includes a molding machine 2, a conveyance line 3, a laser marking apparatus 4, a pouring machine 5, and a line controller 6.

The molding machine 2 is a machine which manufactures a mold M. For example, the mold M is a sand mold formed of green sand. The green sand contains silica sand, bentonite, and a predetermined additive. The molding machine 2 forms the mold M from green sand with water added as a material. The molding machine 2 forms the mold M using a molding flask F. The molding machine 2 is communicably connected to the line controller 6. When receiving a molding start signal from the line controller 6, the molding machine 2 starts manufacturing the mold M in a molding area. The molding machine 2 charges sand (green sand) into the molding flask F in which a pattern is set and compacts the sand inside the molding flask F by applying pressure to the sand. The molding machine 2 forms the mold M by taking the pattern out of the compacted sand. The molding machine 2 transmits a molding completion signal to the line controller 6. The molding completion signal is a signal indicating that the molding machine 2 has been able to mold the mold M through a normal operation.

The conveyance line 3 is a facility which conveys molds. The conveyance line 3 receives the mold M from the molding machine 2 and conveys the mold M to the pouring machine 5. The conveyance line 3 includes, for example, a roller conveyor, a rail, a carriage which travels on the rail with the mold M and the molding flask F placed thereon, a pusher device which is disposed at the molding machine 2 side, and a cushion device which is disposed at the pouring machine 5 side. The roller conveyor or the rail linearly extends from the molding machine 2 to the pouring machine 5. The roller conveyor or the rail may extend not linearly, but, for example, in a step-like manner. The roller conveyor or the rail may extend in a single stroke manner between the molding machine 2 and the pouring machine 5. The conveyance line 3 sequentially conveys a plurality of molds M and molding flasks F, which are arrayed at regular intervals on the roller conveyor or the rail, from the molding machine 2 to the pouring machine 5. The conveyance line 3 is intermittently driven and conveys the molds M and molding flasks F by a predetermined number of flasks at each drive. The predetermined number of flasks may be one flask or may be a plurality of flasks. The conveyance line 3 is communicably connected to the line controller 6. When receiving a flask feeding signal from the line controller 6, the conveyance line 3 conveys the molds M and molding flasks F by the predetermined number of flasks. Upon completion of the conveyance of the predetermined number of flasks, the conveyance line 3 transmits a flask feeding completion signal to the line controller 6. The conveyance line 3 may transmit the flask feeding completion signal to the line controller 6 when positioning of the conveyed molds M and molding flasks F is completed.

The laser marking apparatus 4 is provided on the conveyance line 3 and performs marking on the mold M on the conveyance line 3 by using laser light. The laser marking apparatus 4 can be communicably connected to the line controller 6. The laser marking apparatus 4, the conveyance line 3, and the line controller 6 constitute a laser marking system when operating in cooperation with each other. Details of the laser marking apparatus 4 will be described later.

The pouring machine 5 is a machine which pours molten metal into the mold M. The pouring machine 5 is communicably connected to the line controller 6. When receiving the flask feeding completion signal from the line controller 6, the pouring machine 5 pours molten metal into the mold M located in a pouring area as a pouring target. The pouring machine 5 receives mold information from the line controller 6 and pours molten metal under a condition based on the mold information. The mold M with molten metal is conveyed to an area where a downstream process is performed through the conveyance line 3.

A core set place W may be provided between the molding machine 2 and the pouring machine 5. An operator stays in the core set place W and sets a core in the mold M. Alternatively, an apparatus may automatically set the core in the mold M.

The line controller 6 is a controller which performs centralized control of the casting system 1. The line controller 6 is configured as, for example, a programmable logic controller (PLC). The line controller 6 may be configured as a computer system including a processor, such as a central processing unit (CPU), a memory, such as a random access memory (RAM) and a read only memory (ROM), an input/output device, such as a touch panel, a mouse, a keyboard, or a display, and a communication device, such as a network card. The line controller 6 implements the function of the line controller 6 by operating each hardware under control of the processor based on a computer program stored in the memory.

### Details of Laser Marking Apparatus

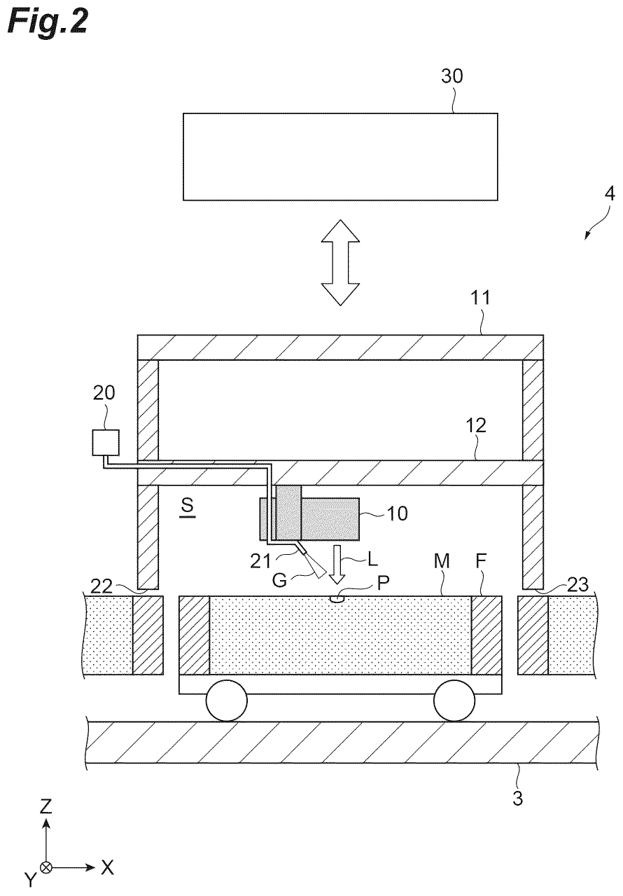

FIG. 2 is a sectional view illustrating an example of the configuration of the laser marking apparatus according to one embodiment. As illustrated in FIG. 2, the laser marking apparatus 4 includes a head 10, a blowing unit 20, and a control unit 30.

The head 10 marks an identifier on the mold M by applying laser light L to the surface of the mold M. The identifier is a character, a number, or a symbol given to an object, and to mark means to place the character, the number, or the symbol on the mold. The surface of the mold M is a face appearing on the outer side of the mold M and includes not only the uppermost face, but also a face defining a product shape (the face to which the product shape is transferred). Hereinbelow, a case where marking is performed on an intended marking point P on the surface of the mold M will be described as an example.

The head 10 is a component which focuses the laser light L at the intended marking point P. The head 10 is connected to a light source (not illustrated) which generates laser light. For example, the head 10 includes a galvanometer mirror (not illustrated) and a focusing lens (not illustrated) and adjusts an irradiation position and a focal length of the laser light L. The head 10 focuses the focal length of the laser light L at the intended marking point P on the surface of the mold M to mark the identifier. The intended marking point P is set within a predetermined range on the mold M. The head 10 is housed in an operation space S which is defined inside a case 11. The head 10 is supported by a frame member 12 which is disposed in the operation space S.

The case 11 includes a carrying-in port 22 and a carrying-out port 23 which communicate with the operation space S. The case 11 is provided on the conveyance line 3 in such a manner that the mold M is carried into and carried out of the operation space S through the carrying-in port 22 and the carrying-out port 23. For example, in a case where the conveyance line 3 is straight, the carrying-in port 22 and the carrying-out port 23 are formed on the case 11 in such a manner as to be opposed to each other. The case 11 is provided on the conveyance line 3 in such a manner that the opposed direction of the carrying-in port 22 and the carrying-out port 23 coincides with the extending direction of the conveyance line 3.

The blowing unit 20 blows gas G onto the surface of the mold M. The blowing unit 20 is a device which delivers the gas G, such as a fan, a compressor, or a blower. In a case where the blowing unit 20 is a compressor or a blower, the blowing unit 20 includes a blow-out nozzle 21 (an example of the nozzle) which blows the gas G toward the surface of the mold M. The blow-out nozzle 21 is, for example, provided on the head 10. The blow-out nozzle 21 may be supported by the frame member 12. In a case where the blowing unit 20 is a fan, the blowing unit 20 may be supported by the head 10 or the frame member 12.

The control unit 30 controls the head 10. The controlling means determining position and operation. The control unit 30 is configured as, for example, a PLC. The control unit 30 may be configured as the computer system described above. The control unit 30 may be disposed outside the case 11 or may be disposed inside the case 11.

The control unit 30 mainly controls output, the irradiation position, and the focal length of the laser light L. The control unit 30 controls the output, the irradiation position, and the focal position of the laser light L by controlling the laser light source, the galvanometer mirror, and the focusing lens. The head 10 marks the identifier on the intended marking point P in accordance with the control of the control unit 30. Water or the like contained in the mold M evaporates due to the application of the laser light L.

The control unit 30 may control operation of the blowing unit 20. In this case, the control unit 30 outputs, for example, a start signal, an end signal, and a signal indicating a target pressure to the blowing unit 20. The blowing unit 20 operates in accordance with a signal received from the control unit 30. The control unit 30 causes the head 10 to mark the identifier while the blowing unit 20 blows the gas G. After causing the blowing unit 20 to start a blowing operation, or simultaneously with the start of the blowing operation, the control unit 30 operates the head 10 to cause the head 10 to mark the identifier on the mold M.

### Other Configuration Examples of Laser Marking Apparatus

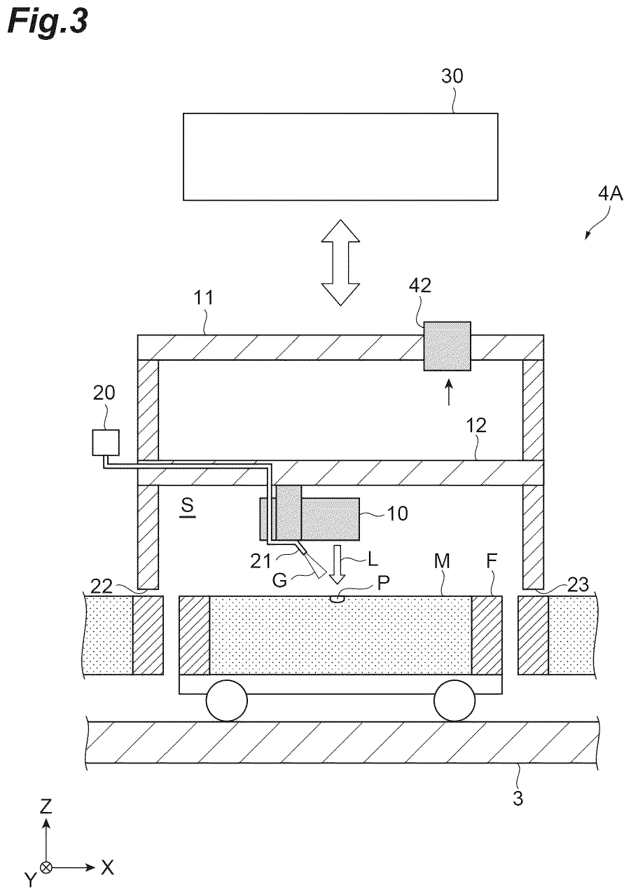

FIG. 3 is a sectional view illustrating an example of a laser marking apparatus including a dust collector. As illustrated in FIG. 3, a laser marking apparatus 4A further includes a dust collector 42 which is connected to the operation space S. The dust collector 42 is provided on the case 11 which defines the operation space S. The dust collector 42 sucks inside air in the operation space S, takes thereinto vapor or a residue generated from the mold M due to marking, and collects dust or the like, thereby purifying the inside air in the operation space S. The other configurations of the laser marking apparatus 4A are the same as those of the laser marking apparatus 4 illustrated in FIG. 2.

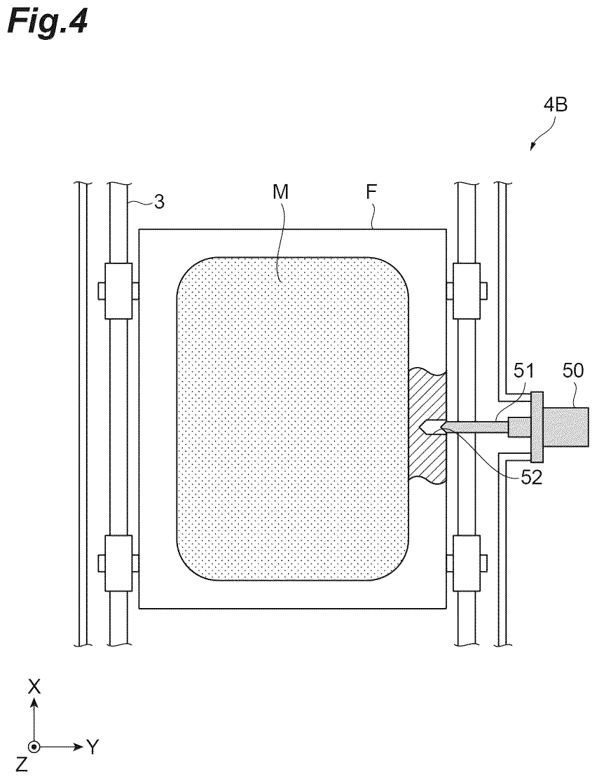

FIG. 4 is a top view illustrating an example of a laser marking apparatus including a positioning unit. As illustrated in FIG. 4, a laser marking apparatus 4B further includes a positioning unit 50 which fixes the mold M at a predetermined operation position.

The positioning unit 50 mechanically fixes the mold M at the predetermined operation position. For example, the positioning unit 50 includes a pin 51. The pin 51 is a wedge member which moves back and forth in a direction perpendicular to the traveling direction of the mold M. The pin 51 has a shape tapered toward the tip thereof. A hole 52 which is engageable with the pin 51 is provided on the molding flask F. The diameter of the hole 52 is slightly larger than the diameter of the pin 51. The hole 52 has an inner face whose diameter gradually decreases toward the bottom thereof. When the mold M is carried into the predetermined operation position, the pin 51 is inserted into the hole 52. The positioning unit 50 receives a carrying-in completion signal from the line controller 6 and inserts the pin 51 into the hole 52. The positioning unit 50 may insert the pin 51 into the hole 52 in accordance with an instruction from the line controller 6 or an instruction from the control unit 30 which has received the carrying-in completion signal. The carrying-in completion signal is a signal indicating that the carrying-in of the mold M has been completed. The mold M on the conveyance line 3 is accurately fixed at the predetermined operation position by the engagement between the pin 51 and the inner face of the hole 52. The other configurations of the laser marking apparatus 4B are the same as those of the laser marking apparatus 4 illustrated in FIG. 2.

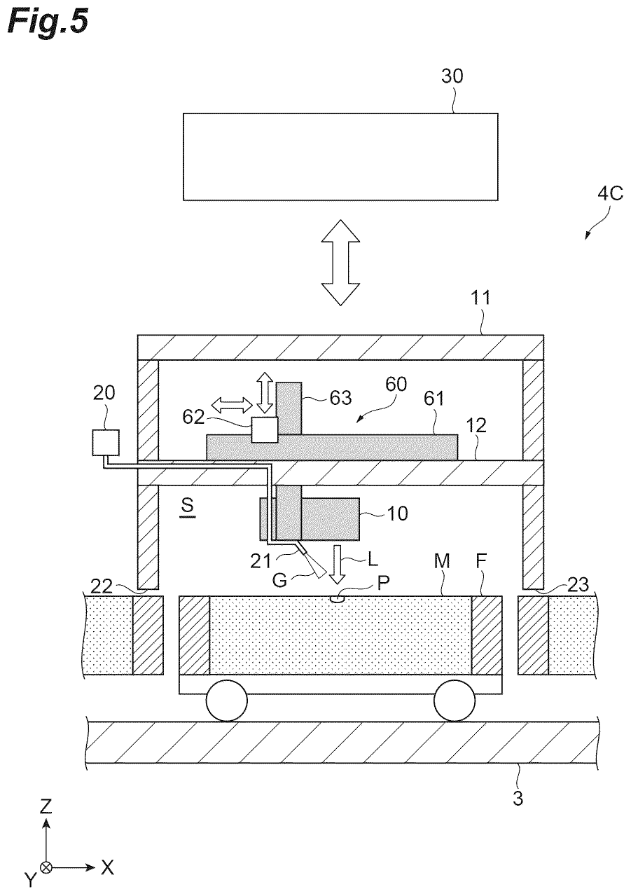

FIG. 5 is a sectional view illustrating an example of a laser marking apparatus including a robot. As illustrated in FIG. 5, a laser marking apparatus 4C further includes a robot 60 which changes the vertical position (X direction), the horizontal position (Y direction), and the height position (Z direction) of the head 10. The robot 60 is a three-axis orthogonal robot which moves the head 10 in the X direction, the Y direction, and the Z direction.

The robot 60 is, for example, provided on the frame member 12. The robot 60 includes an X-axis driving unit 61, a Y-axis driving unit 62, and a Z-axis driving unit 63. The X-axis driving unit 61 moves the head 10 in the X-axis direction. The Y-axis driving unit 62 moves the head 10 in the Y-axis direction. The X-axis driving unit 61 and the Y-axis driving unit 62 move the head 10 within a horizontal plane which is parallel to the surface of the mold M. The X-axis driving unit 61 and the Y-axis driving unit 62 are capable of changing the horizontal position of the head 10 in accordance with the position of the intended marking point P. The Z-axis driving unit 63 moves the head 10 in the Z-axis direction. The Z-axis driving unit 63 moves the head 10 in the vertical direction with respect to the surface of the mold M. The Z-axis driving unit 63 is capable of changing the height position of the head 10 in accordance with the position of the intended marking point P. The robot 60 is connected to the control unit 30. The robot 60 receives an operation command from the control unit 30 and adjusts the position of the head 10 in accordance with the operation command.

The robot 60 may include an additional shaft which changes a tilt or a circumferential direction around an axis extending in the vertical direction from the intended marking point P of the head 10. In this case, the robot 60 is capable of adjusting the tilt of the head 10 so that the laser light L emitted from the head 10 becomes perpendicular to the surface of the mold M. The other configurations of the laser marking apparatus 4C are the same as those of the laser marking apparatus 4 illustrated in FIG. 2. The blow-out nozzle 21 moves integrally with the head 10. The integrally moving means moving in the same direction without changing the relative position between the blow-out nozzle 21 and the head 10. In the case where the blow-out nozzle 21 is supported by the frame member 12, the blow-out nozzle 21 may be moved by a driving mechanism different from the robot 60.

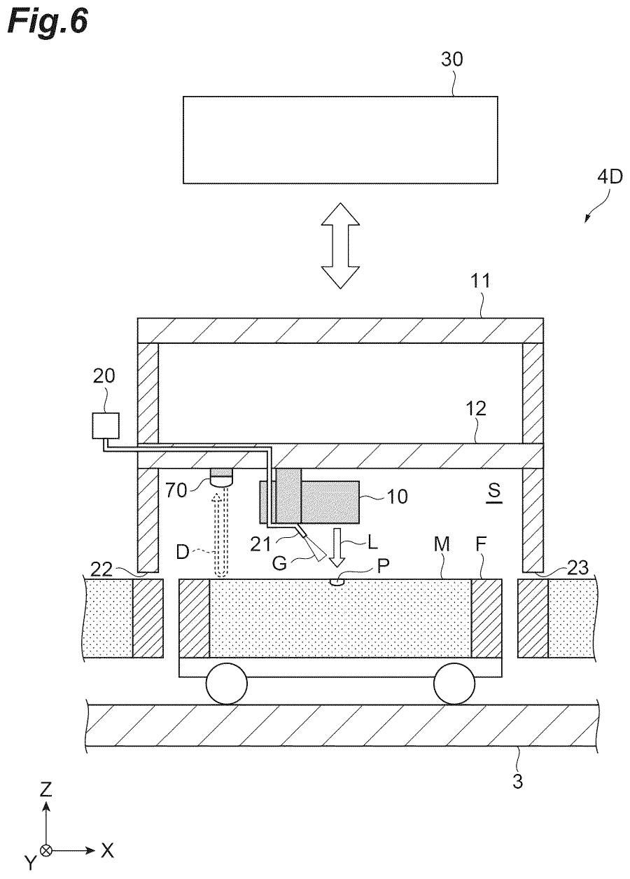

FIG. 6 is a sectional view illustrating an example of a laser marking apparatus including a measurement unit. As illustrated in FIG. 6, a laser marking apparatus 4D further includes a measurement unit 70 which measures the distance between the head 10 and the surface of the mold M, and the control unit 30 adjusts the focal length of the laser light L on the basis of the distance measured by the measurement unit 70.

The measurement unit 70 measures the distance between the head 10 and the surface of the mold M. The measurement unit 70 is, for example, a laser range finder. The measurement unit 70 is provided on the frame member 12. The measurement unit 70 applies measurement light D to the surface of the mold M. The measurement unit 70 measures the height position of the surface of the mold M from a phase difference or a time difference between the measurement light D and reflected light reflected from the surface of the mold M. The measurement unit 70 may measure the height position of the surface of the mold M on the basis of a triangulation method. The distance between the head 10 and the surface of the mold M can be calculated as the difference between the height position of the head 10 and the height position of the surface of the mold M. In a case where the head 10 is fixed to the frame member 12 as illustrated in FIG. 6, the height position of the head 10 is previously measured and stored. The measurement unit 70 calculates the difference between the previously-stored height position of the head 10 and the measured height position of the surface of the mold M to calculate the distance between the head 10 and the surface of the mold M.

The height position of the surface of the mold M varies according to operation conditions of the molding machine 2 during molding, the properties of the green sand, or wear of the rail or a roller. Thus, the distance between the head 10 and the surface of the mold M also varies. The control unit 30 adjusts the focal length of the laser light L on the basis of the distance between the head 10 and the surface of the mold M. The control unit 30 controls the galvanometer mirror and the focusing lens so that the focus of the laser light L is located on the surface of the mold M.

In the case where the height position of the head 10 is adjusted by the robot 60 illustrated in FIG. 5, the control unit 30 may adjust the height position of the head 10 so that the focus of the laser light L is located on the surface of the mold M. The measurement unit 70 acquires the height position of the head 10 from the control unit 30. The height position of the head 10 is a position to which the head 10 is moved by the Z-axis driving unit 63. The measurement unit 70 calculates the difference between the acquired height position of the head 10 and the measured height position of the surface of the mold M to calculate the distance between the head 10 and the surface of the mold M. In this case, the control unit 30 adjusts at least one of the height position of the head 10 and the focal length of the laser light L on the basis of the distance between the head 10 and the surface of the mold M.

The distance between the head 10 and the surface of the mold M may be calculated on the basis of the difference between the height position of the surface of a reference mold M and the height position of the surface of another mold M. In this case, the distance between the head 10 and the surface of the reference mold M is previously measured, and the focal length of the laser light L is adjusted. The measurement unit 70 calculates the difference between the previously-stored height position of the surface of the reference mold M and the measured height position of the surface of another mold M and adjusts the height position of the head 10 so that the distance between the head 10 and the surface of the mold M becomes an appropriate distance or adjusts the focal length of the laser light L on the basis of the calculated difference.

The measurement unit 70 may be provided on the head 10. In this case, the measurement unit 70 is capable of directly measuring the distance between the head 10 and the surface of the mold M. The measurement unit 70 is not limited to the laser range finder and may be an ultrasound range finder. The measurement unit 70 may measure the distance using a probe. The measurement unit 70 may measure the distance by image recognition. A plurality of measurement units 70 may be provided. The other configurations of the laser marking apparatus 4D are the same as those of the laser marking apparatus 4 illustrated in FIG. 2.

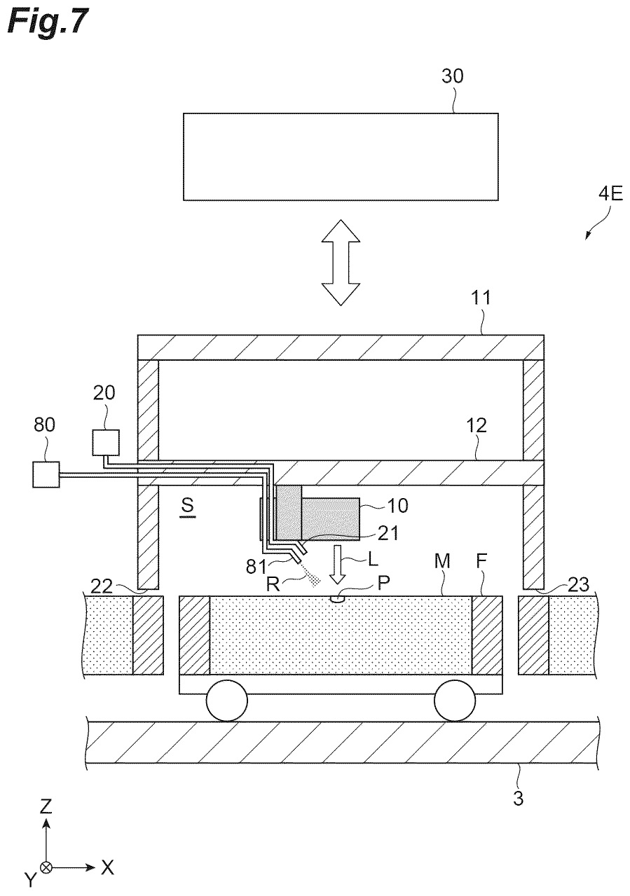

FIG. 7 is a sectional view illustrating an example of a laser marking apparatus including a spraying unit. As illustrated in FIG. 7, a laser marking apparatus 4E further includes a spraying unit 80 which sprays liquid R onto the surface of the mold M after the head 10 marks the identifier on the mold M.

The spraying unit 80 sprays the liquid R onto the surface of the mold M. The spraying unit 80 is a device which delivers the liquid R and includes, for example, a pump (not illustrated), a valve (not illustrated), and a tank (not illustrated) for the liquid R. The spraying unit 80 includes a spraying nozzle 81 which sprays the liquid R toward the surface of the mold M. The spraying nozzle 81 is, for example, provided on the head 10. The spraying nozzle 81 may be supported by the frame member 12. The spraying unit 80 sprays the liquid R from the spraying nozzle 81 onto the mold M, for example, by driving the pump and opening the valve. The spraying unit 80 stops the spraying of the liquid R by closing the valve.

The liquid R is, for example, water or an additive. The additive is, for example, a surface stabilizer or a coat. The stabilizer includes, for example, sugar alcohol. The surface stabilizer improves the water retaining capacity of green sand. The coat includes, for example, silicon. The coat forms a thin film on the surface of the mold M to prevent seizure of the mold M. Water evaporating due to the application of the laser light L is compensated with the liquid sprayed by the spraying unit 80.

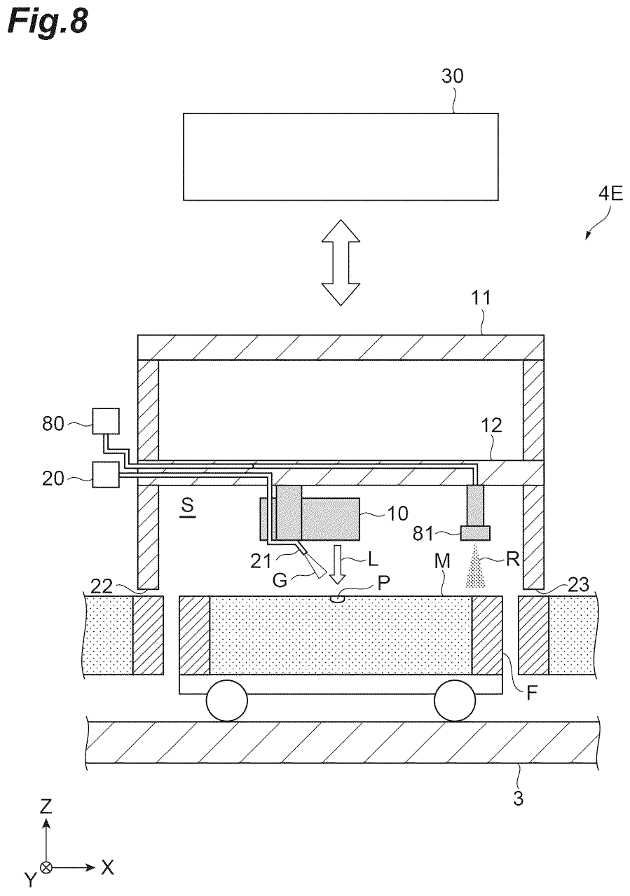

FIG. 8 is a sectional view illustrating another example of the laser marking apparatus 4E including the spraying unit. As illustrated in FIG. 8, the spraying nozzle 81 may be provided on the frame member 12. In the example of FIG. 8, the conveyance line 3 conveys the mold M rightward in the drawing. The spraying nozzle 81 is provided downstream of the head 10 and sprays the liquid R onto the mold M to which the laser light L has been applied by the head 10. The other configurations of the laser marking apparatus 4E are the same as those of the laser marking apparatus 4 illustrated in FIG. 2.

### Operation of Laser Marking System

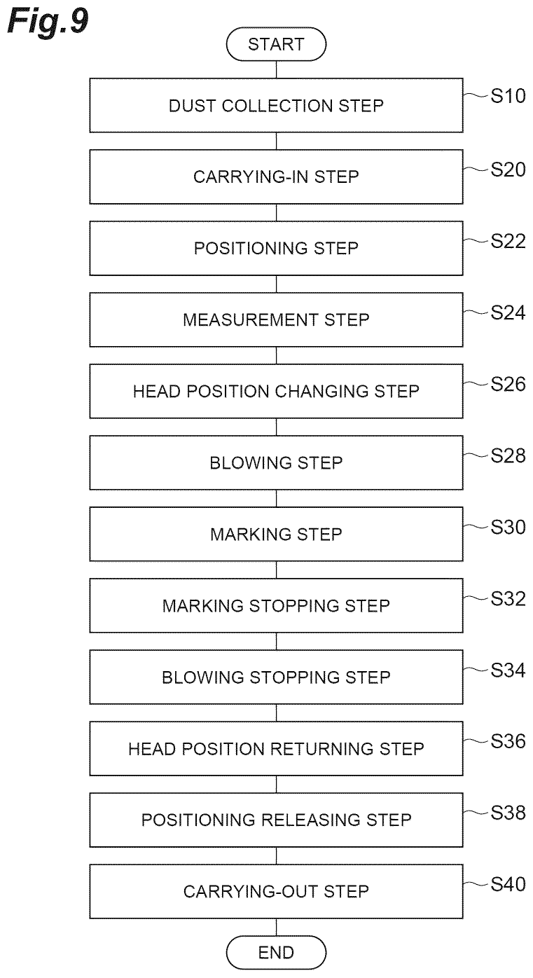

FIG. 9 is a flowchart illustrating an example of operation of the laser marking system. The laser marking system includes the conveyance line 3, the line controller 6, and the laser marking apparatus. Hereinbelow, a case where the laser marking apparatus has all the functions of the above laser marking apparatuses 4, 4A to 4E will be described as an example.

The flowchart of FIG. 9 is started, for example, in accordance with a start instruction from an operator. At the start of the system, the operator or the control unit 30 starts the operation of the dust collector 42 (step S10). The dust collector 42 starts dust collection in the operation space S.

Next, the line controller 6 carries the mold M into the operation space S of the laser marking apparatus by operating the conveyance line 3 (step S20). For example, when the mold M has been conveyed to a predetermined position, the line controller 6 transmits a conveyance completion signal to the control unit 30. The line controller 6 may detect that the mold M has been conveyed to the predetermined position by using, for example, a sensor or determine it on the basis of a predetermined number of conveyed flasks.

Next, the positioning unit 50 fixes the mold M conveyed into the operation space S at the predetermined operation position (step S22). The control unit 30 may operate the positioning unit 50 after receiving the carrying-in completion signal. The positioning unit 50 engages the pin 51 with the hole 52 of the molding flask F. The mold M is accurately fixed at the predetermined operation position by the engagement between the pin 51 and the inner face of the hole 52.

Next, the measurement unit 70 measures the distance between the head 10 and the surface of the mold M (step S24). The measurement unit 70 measures the height position of the surface of the mold M from, for example, the phase difference or the time difference between the measurement light D and the reflected light reflected from the surface of the mold M, or by triangulation. The distance between the head 10 and the surface of the mold M can be calculated as the difference between the height position of the head 10 and the height position of the surface of the mold M. The measurement unit 70 may come into operation in response to completion of the positioning of the mold M. The control unit 30 adjusts the focal length of the laser light L on the basis of the distance measured by the measurement unit 70.

Next, the robot 60 changes the position of the head 10 (step S26). The robot 60 changes the vertical position, the horizontal position, and the height position of the head 10 in accordance with the position of the intended marking point P. For example, the robot 60 changes the vertical position and the horizontal position of the head 10 so that the intended marking point P on the surface of the mold M is located within a laser irradiation range irradiated with laser light by the driving of the galvanometer mirror of the head 10. Then, the robot 60 adjusts the height position of the head 10 so that the focus of the laser light L is located on the surface of the mold M on the basis of the result obtained by the measurement unit 70.

Next, the blowing unit 20 blows the gas G onto the surface of the mold M (step S28). The blowing unit 20 starts and continues the blowing of the gas G.

Next, the control unit 30 causes the head 10 to mark the identifier during the blowing performed by the blowing unit 20 (step S30). The head 10 drives the galvanometer mirror and marks the identifier on the surface of the mold M. At this time, water or the like contained in the mold M turns to vapor due to the application of the laser light L. Vapor or a residue generated from the mold M due to the application of the laser light L is removed from the surface of the mold M by the blowing unit 20 blowing gas onto the surface of the mold M. The laser light L is applied to the surface of the mold M while maintaining a set laser light output without being blocked by the vapor or residue generated from the mold M. The generated vapor or residue is collected by the dust collector 42.

Next, the head 10 stops the application of the laser light L to the mold M to stop the marking of the identifier (step S32). Then, the blowing unit 20 stops the blowing of the gas G (step S34). The blowing unit 20 stops the blowing of the gas G, for example, in response to the stop of the marking of the identifier. The robot 60 first returns the height position of the head 10 and then returns the vertical position and the horizontal position of the head 10 to the positions before moved (step S36). The robot 60 may return the position of the head 10 to a predetermined original point.

Next, the positioning unit 50 releases the fixation of the mold M (step S38). The engagement between the hole 52 of the molding flask F and the pin 51 is released, which enables the mold M to be conveyed. At last, the line controller 6 carries the mold M out of the laser marking apparatus by operating the conveyance line 3 (step S40). In this manner, the flowchart of FIG. 9 is finished.

When the marking system continuously performs the marking operation, a new mold M is carried in in response to the carrying-out of the mold M (step S20). Thereafter, the processes of steps S20 to S40 are repeatedly executed. When the marking system comes to a stop, the dust collector 42 stops the operation in response to the stop of the system.

### Summary of Embodiment

According to the laser marking apparatuses 4, 4A to 4E and the laser marking method, the gas G is blown onto the surface of the mold M. The laser light L is applied to the surface of the mold M during the blowing of the gas G. Vapor or a residue generated from the mold M due to the application of the laser light L is removed from the surface of the mold M by the blowing unit 20 blowing the gas G onto the surface of the mold M. Thus, the laser light L is applied to the surface of the mold M while maintaining the set output of the laser light L without being blocked by the vapor or residue generated from the mold M. The laser marking apparatus 4 and the laser marking method can reduce the influence of the vapor or residue generated from the mold M due to the application of the laser light L on the marking operation.

According to the laser marking apparatus 4A, the vapor or residue removed from the surface of the mold M by the blowing unit 20 is collected by the dust collector 42. Thus, the laser light L is applied to the surface of the mold M while maintaining the set output of the laser light L without being blocked by the generated vapor or residue. The laser marking apparatus 4A can further reduce the influence of the vapor or residue generated from the mold M due to the application of the laser light L on the marking operation as compared to a laser marking apparatus that does not include the dust collector 42.

According to the laser marking apparatus 4B, the conveyed mold M is marked after being fixed at the predetermined operation position by the positioning unit 50. The laser marking apparatus 4B can suppress the occurrence of misalignment or marking failure of the identifier caused by misalignment of the mold M as compared to a laser marking apparatus that does not include the positioning unit 50.

According to the laser marking apparatus 4C, the vertical position, the horizontal position, and the height position of the head 10 can be changed by the robot 60. According to the laser marking apparatus 4D, the control unit 30 adjusts the distance between the head 10 and the surface of the mold M to a set value on the basis of the distance measured by the measurement unit 70. The laser marking apparatus 4D can clearly mark the identifier on the mold M even when the height position of the surface of the mold M varies as compared to a laser marking apparatus that does not include the measurement unit 70.

According to the laser marking apparatus 4E, water evaporating due to marking is compensated with the liquid sprayed by the spraying unit 80. The laser marking apparatus 4E can reduce the influence of the marking operation on the quality of the mold M.

### Modifications

Although various explanatory embodiments have been described above, the present disclosure is not limited to the above explanatory embodiments, and various omissions, replacements, and modifications may be made.

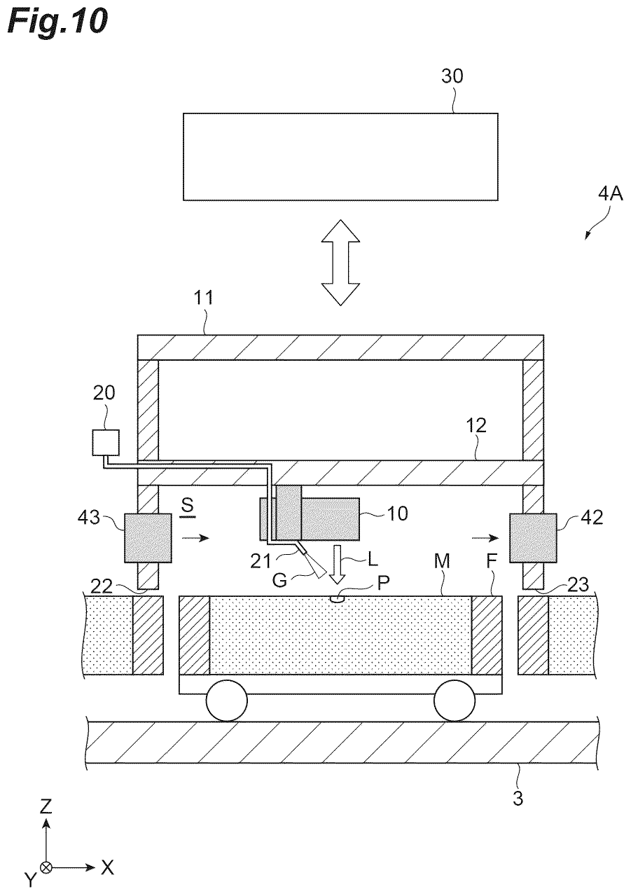

For example, the laser marking apparatus including the dust collector is not limited to the example illustrated in FIG. 3. FIG. 10 is a sectional view illustrating another example of the laser marking apparatus including the dust collector. A laser marking apparatus 4A illustrated in FIG. 10 differs from the laser marking apparatus 4A illustrated in FIG. 3 in that an auxiliary device 43 is provided and the dust collector 42 is disposed facing the auxiliary device 43, and is the same as the laser marking apparatus 4A illustrated in FIG. 3 in the other configurations. The dust collector 42 and the auxiliary device 43 are provided on the case 11 which defines the operation space S. The auxiliary device 43 generates an air current toward the dust collector 42. The air current generated between the auxiliary device 43 and the dust collector 42 conveys, to the dust collector 42, vapor or a residue generated from the mold M due to marking. Thus, the dust collection effect of the dust collector 42 is improved.

The laser marking apparatus 4 is not limited to the mode that marks the identifier on the mold formed of sand. The laser marking apparatus 4 can also mark the identifier on a self-hardening mold, a thermosetting mold, or a gas-hardening mold. The laser marking apparatus 4 can mark the identifier not only on the mold, but also on the core. The mold described in the present disclosure includes the mold described above, the self-hardening mold, the thermosetting mold, the gas-hardening mold, and the core.

Although the embodiment of the present disclosure describes the example using, as the molding machine 2, a flask type molding machine that alternately molds a cope and a drag in cope and drag flasks, the present disclosure is not limited thereto. Alternatively, for example, the present disclosure may be applied to a flaskless molding machine in which a cope and a drag are simultaneously molded, then joined together, then taken out of cope and drag flasks, and then carried out of the molding machine 2 without the flasks.

The positioning unit 50 may include engagement means different from the pin 51 which is engageable with the hole 52 provided on the lateral side of the molding flask F. The positioning unit 50 may include a bush (or a pin) which is engageable with a pin (or a bush) provided in a standing manner on the upper face of the molding flask F. In this case, the positioning unit 50 may operate the bush (or the pin) downward from above the molding flask F.

The robot 60 is not limited to the orthogonal robot. The robot 60 may be, for example, a multi-articulated robot, a parallel-link robot, or a SCARA robot.

A spraying device which sprays liquid R onto the mold M being conveyed may be provided on the conveyance line 3. The spraying device is provided, for example, between the laser marking apparatus 4 and the pouring machine 5.

As obvious from the description for the example of the operation of the laser marking apparatus illustrated in FIG. 9, the laser marking apparatus can have all the functions of the laser marking apparatuses 4, 4A to 4E. Moreover, the laser marking apparatus of the present disclosure can have any function selected from the functions of the laser marking apparatuses 4, 4A to 4E.

### REFERENCE SIGNS LIST

3 conveyance line, 4 laser marking apparatus,
10 head, 11 case, 20 blowing unit, 30 control unit, 42 dust
collector, 50 positioning unit, 60 robot, 70 measurement unit, 80
spraying unit, G gas, L laser light, M mold, R liquid, S
operation space.

What is claimed is:

1: A laser marking system comprising:
a conveyance line for carrying a mold;
a blowing unit configured to blow gas onto a surface of the mold;
a head configured to mark an identifier on the mold by applying laser light to the surface of the mold;
a case defining an operation space for marking the identifier, the case including a carrying-in port and a carrying-out port which communicate with the operation space, the case provided on the conveyance line for carrying the mold in such a manner that the mold is carried into and carried out of the operation space through the carrying-in port and the carrying-out port; and
a control unit configured to cause the head to mark the identifier while the blowing unit blows the gas.

2: The laser marking system according to claim 1, wherein the conveyance line includes a roller conveyor, a rail, and a carriage which travels on the rail with the mold placed thereon.

3: The laser marking system according to claim 1, wherein the carrying-in port and the carrying-out port are aligned along a conveyance direction of the conveyance line with one of the ports located upstream of another of the ports in the conveyance direction.

4: The laser marking system according to claim 1, wherein the case is provided on the conveyance line in such a manner that an opposed direction of the carrying-in port and the carrying-out port in which the carrying-in port and the carrying-out port face each other coincides with a conveying direction of the conveyance line.

5: The laser marking system according to claim 1, further comprising a spraying unit configured to spray liquid onto the surface of the mold after the head marks the identifier.
